(19) United States
(12) Patent Application Publication
(10) Pub. No.: US 2025/0197225 A1
(43) Pub. Date: Jun. 19, 2025

(54) Negative Electrode Active Material for Secondary Battery, Manufacturing Method Thereof, Negative Electrode for Secondary Battery and Secondary Battery

(71) Applicants: Shinshu University, Matsumoto City, Nagano (JP); Meijo Nano Carbon Co., Ltd., Nagoya-shi, Aichi (JP)

(72) Inventors: Nobuyuki Zettsu, Nagano City (JP); Natsumi Kawabe, Nagano City (JP)

(21) Appl. No.: 18/846,636

(22) PCT Filed: Mar. 16, 2023
(86) PCT No.: PCT/JP2023/010381

§ 371 Date: Sep. 12, 2024

(30) Foreign Application Priority Data
Mar. 16, 2022 (JP) 2022-041246

(51) Int. Cl. C01B 33/021; H01M 10/0569

(52) U.S. Cl. CPC C01B 33/021; H01M 10/0569; C01P 2004/03; C01P 2004/84; C01P 2006/40; H01M 2300/0034

(57) ABSTRACT

A negative electrode active material for a secondary battery (102) of the present invention contains an active material particle (106) which contains a silicon composite (103) and a self-assembled monolayer 104 that covers a surface of the silicon composite (103) and has an amino group and a binder (105) bonded to the self-assembled monolayer 104 through the amino group, and the binder (105) contains a first carbon nanotube having a length of 1000 nm or less and a second carbon nanotube having a length of 2 μm or more.

### TECHNICAL FIELD

The present invention relates to a negative electrode active material for a secondary battery, a manufacturing method thereof, a negative electrode for a secondary battery and a secondary battery.

Priority is claimed on Japanese Patent Application No. 2022-041246, filed Mar. 16, 2022, the content of which is incorporated herein by reference.

### BACKGROUND ART

For an increase in the energy densities of lithium-ion batteries, attention is being paid to alloy-based materials such as silicon as a new material that replaces graphite, which is a conventional negative electrode material (for example, Non-Patent Documents 1 to 3). Silicon has a specific capacity nearly four times larger than that of graphite, but also significantly expands in volume when occluding lithium ions. Therefore, in the case of using silicon as a negative material of a secondary battery, it is known that crushing of active material particles in association with the charge/discharge cycle of the secondary battery or capacity deterioration due to the poor contact with an auxiliary conductive agent is caused. It is also known that, due to the formation of a coating during the initial charging reaction, furthermore, an activation reaction following the crushing of active materials or the generation of an unacceptable capacity following the generation of Li₄SiO₄, the number of lithium ions in the positive electrode becomes small and the capacity deteriorates.

### CITATION LIST

### Non-Patent Document

[Non-Patent Document 1]
   T. Hirose et al., Solid State Ionics 303 (2017) pp. 154 to 160
[Non-Patent Document 2]
   T. Hirose et al., Solid State Ionics 304 (2017) pp. 1 to 6
[Non-Patent Document 3]
   T. Hirose et al., Solid State Communications 269 (2018) pp. 39 to 44

### SUMMARY OF INVENTION

### Technical Problem

The present invention has been made in consideration of the above-described circumstance, and an object of the present invention is to provide a secondary battery in which capacity deterioration caused by the repetition of charging and discharging is suppressed, a negative electrode active material for a secondary battery that configures the same secondary battery, a manufacturing method thereof, and a negative electrode for a secondary battery.

### Solution to Problem

In order to achieve the aforementioned object, the present invention employs the following means.

(1) A negative electrode active material for a secondary battery according to one aspect of the present invention includes an active material particle which contains a silicon composite and a self-assembled monolayer that covers a surface of the silicon composite and has an amino group and a binder containing a carbon compound bonded to the self-assembled monolayer through the amino group, and the carbon compound contains a first carbon nanotube having a length of 1000 nm or less and a second carbon nanotube having a length of 2 μm or more.

(2) In the negative electrode active material for a secondary battery according to the (1), the binder is preferably contained in a fraction of 1 wt % or more and 15 wt % or less.

(3) In the binder of the negative electrode active material for a secondary battery according to the (1) or (2), the second carbon nanotube is preferably contained in a fraction of 1 wt % or more and 15 wt % or less.

(4) In the negative electrode active material for a secondary battery according to any one of the (1) to (3), it is preferable that the first carbon nanotube is a multi-walled carbon nanotube and the second carbon nanotube is a single-walled carbon nanotube.

(5) A negative electrode for a secondary battery according to one aspect of the present invention is a negative electrode for a secondary battery in which the negative electrode active material for a secondary battery according to any one of the (1) to (4) is used and includes a current collector and the negative electrode active material for a secondary battery formed on one surface side of the current collector.

(6) The negative electrode for a secondary battery according to the (5), in which a carbon film may be further provided between one surface of the current collector and the negative electrode active material for a secondary battery.

(7) A secondary battery according to one aspect of the present invention includes the negative electrode for a secondary battery according to any one of the (5) or (6), a positive electrode for a secondary battery and an electrolytic solution which is loaded between the negative electrode for a secondary battery and the positive electrode for a secondary battery, and a fraction of fluoroethylene carbonate that is contained in the electrolytic solution is preferably 15 wt % or less.

(8) A manufacturing method of a negative electrode active material for a secondary battery according to one aspect of the present invention is a manufacturing method of a negative electrode active material for a secondary battery according to any one of the (1) to (4), including a step of forming a carbon compound body to which a 1-ethyl-3-(3-dimethylaminopropyl) carbodiimide hydrochloride molecule bonds, a step of forming a silicon composite to which an amine has bonded and a step of mixing and amide-bonding the carbon compound body and the silicon composite in a liquid.

### Advantageous Effects of Invention

According to the present invention, it is possible to provide a secondary battery in which capacity deterioration caused by the repetition of charging and discharging is suppressed, a negative electrode active material for a secondary battery that configures the same secondary battery, a manufacturing method thereof and a negative electrode for a secondary battery.

### BRIEF DESCRIPTION OF DRAWINGS

FIG. 1 is an enlarged cross-sectional view of a negative electrode for a secondary battery according to a first embodiment of the present invention.

FIG. 2 is a view in which a bonding part between an active material particle and a binder in a negative electrode active material for a secondary battery in FIG. 1 is enlarged.

FIG. 3 is a view showing a manufacturing step of an active material particle in a manufacturing method of the negative electrode for a secondary battery of FIG. 1.

FIG. 4 is a view showing a manufacturing step of the binder in the manufacturing method of the negative electrode for a secondary battery of FIG. 1.

FIG. 5A is an image diagram of the negative electrode for a secondary battery during expansion of the active material particle.

FIG. 5B is an image diagram of the negative electrode for a secondary battery during shrinkage of the active material particle.

FIG. 6 is an enlarged cross-sectional view of a negative electrode for a secondary battery according to a second embodiment of the present invention.

FIG. 7 is a SEM image of a surface of a negative electrode active material for a secondary battery of Example 1.

FIG. 8 is a SEM image of the surface of the negative electrode active material for a secondary battery of Example 1.

FIG. 9 is graphs showing the cycle test results of discharge capacities regarding secondary batteries in which a negative electrode active material for a secondary battery of Example 1 or Comparative Example 1 or 2 is used.

FIG. 10 is graphs showing the cycle test results of average working voltages regarding the secondary batteries in which a negative electrode active material for a secondary battery of Example 1 or Comparative Example 1 is used.

FIG. 11 is graphs showing the cycle test results of discharge capacities regarding secondary batteries in which a negative electrode active material for a secondary battery of Example 1 or 2 is used.

FIG. 12 is a SEM image of a surface of a negative electrode active material for a secondary battery obtained in Example 3.

FIG. 13 is a SEM image of a surface of a negative electrode active material for a secondary battery obtained in Example 4.

FIG. 14 is graphs showing the cycle test results of discharge capacities relying on the content of the binder regarding secondary batteries in which the negative electrode active material for a secondary battery of one of Examples 2 to 4 is used.

FIG. 15 is graphs showing the cycle test results of discharge capacities relying on the content of the binder regarding secondary batteries in which a negative electrode active material for a secondary battery of one of Examples 5 to 7 is used.

FIG. 16 is SEM images of cross sections of a negative electrode for a secondary battery obtained in Example 6.

FIG. 17 is SEM images of cross sections of a negative electrode for a secondary battery obtained in Example 7.

FIG. 18 is graphs showing the cycle test results of discharge capacities relying on the presence or absence of FEC addition regarding the secondary batteries in which the negative electrode active material for a secondary battery of Example 2 or 5 is used.

FIG. 19 is graphs showing the cycle test results of discharge capacities relying on the presence or absence of FEC addition regarding the secondary batteries in which the negative electrode active material for a secondary battery of Example 3 or 6 is used.

FIG. 20 is graphs showing the cycle test results of discharge capacities relying on the presence or absence of FEC addition under a condition of a discharge time being set to five hours (0.2 C) regarding the secondary batteries in which the negative electrode active material for a secondary battery of Example 4 or 7 is used.

FIG. 21 is graphs showing the cycle test results of the discharge capacity under the condition of the discharge time being set to 0.5 hours (2C) regarding the secondary battery in which the negative electrode active material for a secondary battery of Example 7 is used.

FIG. 22A is graphs showing the charge/discharge curves of the secondary batteries of Examples 2 and 3 that have been charged and discharged repeatedly 10 times.

FIG. 22B is graphs showing the charge/discharge curves of the secondary batteries of Examples 2 and 3 that have been charged and discharged repeatedly 30 times.

FIG. 22C is graphs showing the charge/discharge curves of the secondary batteries of Examples 2 and 3 that have been charged and discharged repeatedly 50 times.

FIG. 23A is graphs showing the dQ/dV curves of the secondary battery of Example 2 that has been charged and discharged repeatedly 10 times, 30 times, and 50 times.

FIG. 23B is graphs showing the dQ/dV curves of the secondary battery of Example 3 that has been charged and discharged repeatedly 10 times, 30 times, and 50 times.

FIG. 24 is graphs showing the dQ/dV curves of the secondary batteries of Examples 2 to 5 that have been charged and discharged repeatedly 50 times.

FIG. 25A is graphs showing the average working characteristics of the secondary batteries of Examples 2 to 5.

FIG. 25B is graphs showing the coulombic efficiencies of the secondary batteries of Examples 2 to 5.

FIG. 26 is images of cross sections of a negative electrode that configures the secondary battery of Example 3 when expanded (left side) and when shrunk (right side).

FIG. 27 is images of cross sections of a negative electrode that configures the secondary battery of Example 5 when expanded (left side) and when shrunk (right side).

FIG. 28A is an image of a surface of a mixture electrode layer of Example 2.

FIG. 28B is an image of a surface of a mixture electrode layer of Example 3.

FIG. 28C is an image of a surface of a mixture electrode layer of Example 4.

FIG. 28D is an image of a surface of a mixture electrode layer of Example 5.

FIG. 29A is an image of a cross section of the mixture electrode layer of Example 2.

FIG. 29B is an image of a cross section of the mixture electrode layer of Example 3.

FIG. 29C is an image of a cross section of the mixture electrode layer of Example 4.

FIG. 29D is an image of a cross section of the mixture electrode layer of Example 5.

FIG. 30A is graphs showing measurement result variations of the volume resistivities of the mixture electrode layers of Examples 2 to 5.

FIG. 30B is graphs showing measurement result variations of the interface resistances of the mixture electrode layers of Examples 2 to 5.

FIG. 30C is graphs showing measurement result variations of the surface resistances of the mixture electrode layers of Examples 2 to 5.

FIG. 31 is graphs showing the charge/discharge curves of a secondary battery of Example 9.

### DESCRIPTION OF EMBODIMENTS

Hereinafter, a negative electrode active material for a secondary battery, a manufacturing method thereof, a negative electrode for a secondary battery and a secondary battery according to an embodiment to which the present invention is applied will be described in detail using drawings. In the drawings to be used in the following description, there are cases where a characteristic part is shown in an enlarged manner for convenience to facilitate the understanding of the characteristics, and the dimensional ratio or the like of each configuration element is not always the same as the actual one. In addition, materials, dimensions and the like in the following description are simply exemplary examples, and the present invention is not limited thereto and can be modified as appropriate within the scope of the gist thereof and carried out.

### First Embodiment

### (Negative Electrode Active Material for Secondary Battery and Negative Electrode for Secondary Battery)

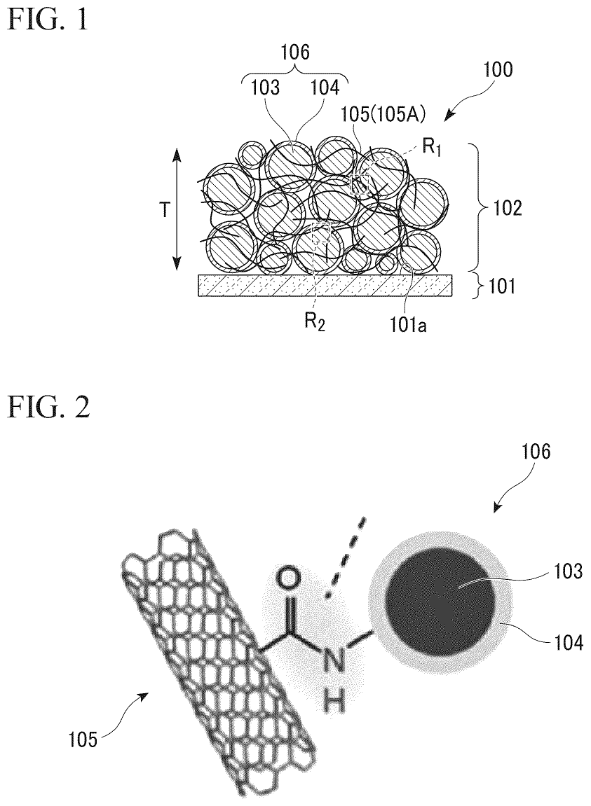

FIG. 1 is a cross-sectional view schematically showing the configuration of a part of a negative electrode for a secondary battery 100 including a mixture electrode layer 102 containing a negative electrode active material for a secondary battery according to a first embodiment of the present invention. In the negative electrode for a secondary battery 100, the mixture electrode layer 102 has been deposited (applied) on one surface 101a of a current collector 101 composed of a conductive member such as a copper foil so as to form a film. The mixture electrode layer 102 contains a plurality of negative electrode active materials for a secondary battery (hereinafter, referred to as the active material particles 106) and a binder (coupling agent) 105 loaded into gaps between the active material particles 106. An auxiliary conductive agent or the like may be loaded into the gaps between the active material particles 106 depending on the use.

The active material particle 106 includes a silicon composite 103 and a self-assembled monolayer 104 that covers the surface of the silicon composite 103 and has an amino group. The binder 105 is bonded to the self-assembled monolayer 104 through the amino group.

The silicon composite 103 is composed of a silicon compound and at least one carbon material of graphite, non-graphitizable carbon (hard carbon) or soft carbon. The silicon composite 103 may further contain either or both of Sn and Li. The silicon compound contains at least one of Si, SiO and SiOₓ (x is a real number).

From the viewpoint of increasing the specific capacity, the silicon compound preferably occupies 5% or more of the volume of the silicon composite 103. The average diameter (a diameter obtained by averaging the particle diameters of a particle of the silicon compound measured in two or more directions) of the silicon compound is preferably 10 nm or more and 15000 nm or less.

As the silicon compound, for example, a composite particle obtained by dispersing a nano-silicon particle having a particle diameter of approximately 100 nm in hollow soft carbon having a particle diameter of approximately 10 μm can be used. The volume ratio between the nano-silicon and the soft carbon in this case is preferably 50:50. In addition, as the silicon compound, for example, a silicon oxide (SiOₓ) particle having a particle diameter of approximately 10000 nm or a primary particle of silicon oxide (SiOₓ) particle having a particle diameter of approximately 1000 nm or the like can also be used.

The self-assembled monolayer 104 is a film composed of the molecule of carbon or the like and having an amino group (—NH₂) formed on a surface. The thickness of the self-assembled monolayer 104 is preferably 1 nm or more and 10 nm or less. In the present embodiment, a case where N-[3-(trimethoxysilyl) propyl] diethylenetriamine (DEADAPTS) is used as the self-assembled monolayer 104 will be described as an example.

The binder 105 contains a long carbon material (structure) 105A containing a carbon atom as a main component. The long carbon material 105A contains two kinds of carbon nanotubes having different sizes and shapes in a mutually mixed state. Hereinafter, one of the two kinds of carbon nanotubes will be referred to as the first carbon nanotube, and the other will be referred to as the second carbon nanotube. The binder 105 may further contain a conductive material such as graphene, reduced graphene oxide, acetylene black, amorphous carbon or a conductive polymer or a coupling agent such as a polyimide or carboxylmethyl cellulose.

The fraction of the binder 105 that is contained in the mixture electrode layer 102 can be freely selected depending on the use and is preferably set to 2 wt % or more from the viewpoint of enhancing the binding force and the conductivity between the active material particles 106 and is preferably set to 6 wt % or less from the viewpoint of securing sufficient capacity characteristics. That is, the fraction of the active material particles 106 in the mixture electrode layer 102 is preferably set to 94 wt % or more and 98 wt % or less for the same reasons.

The first carbon nanotube is distributed so as to closely adhere mainly to the self-assembled monolayer 104 on the surface of the active material particle and functions as a poorly elastic binder capable of deforming along the shape of the surface. The first carbon nanotube configures the skeleton of the binder, plays a role of maintaining the strength thereof and thus has a thick and short shape compared with the second carbon nanotube. Therefore, the length of the first carbon nanotube in the longitudinal direction is 1000 nm or less and preferably 300 nm or more and 700 nm or less. In addition, the diameter of a cross section of the first carbon nanotube perpendicular to the longitudinal direction is preferably 10 nm or more and 40 nm or less and more preferably 20 nm or more and 30 nm or less. Examples of such a first carbon nanotube include multi-walled carbon nanotubes.

The second carbon nanotube functions, similar to the first carbon nanotube, as a poorly elastic binder, but has a higher conductivity than the first carbon nanotube, and has a long and thin shape that is unlikely to cohere and more strongly fastens the active material particles. The second carbon nanotube intricately intertwines with the first carbon nanotube, more strongly fastens the active material particles, is spread throughout all of the surfaces of active material particles, and plays a role of a conduction path. Therefore, the second carbon nanotube has a longer and thinner shape that is more unlikely to cohere and has a higher conductivity than the first carbon nanotube. Therefore, the length of the second carbon nanotube in the longitudinal direction is 2 μm or less and preferably 5 μm or more and 10 μm or less. The diameter of a cross section of the second carbon nanotube perpendicular to the longitudinal direction is preferably 1 nm or more and 5 nm or less and more preferably 2 nm or more and 3 nm or less. Examples of such a second carbon nanotube include single-walled carbon nanotubes.

In the long carbon material 105A, the second carbon nanotube is preferably contained in a fraction of 10 wt % or more. When the fraction of the second carbon nanotube is smaller than 10 wt %, the function of fastening the active material particles weakens. In addition, when the fraction of the second carbon nanotube is too large, the fraction of the first carbon nanotube becomes small, and it becomes difficult to maintain the shape of the active material.

FIG. 2 is a view in which a bonding part between the active material particle 106 and the binder 105 in FIG. 1 is enlarged. The mixture electrode layer 102 has a portion in which the self-assembled monolayer 104 of an organic silane compound and the long carbon material (carbon nanotube) 105A non-covalently bond to each other as shown in FIG. 2. In more detail, in this portion, a positively-charged functional group (—NH³⁺) among the amino groups formed in the self-assembled monolayer 104 and a carboxyl group formed in the long carbon material 105A non-covalently bond to each other due to tension in association with an electrostatic interaction.

The mixture electrode layer 102 may contain an additive binder other than the above-described binder 105 as a binder that further enhances binding between the active material particles 106. Examples of the additive binder include polyvinylidene fluoride (PVDF), polytetrafluoroethylene (PTFE), an ethylene propylene diene copolymer (EPDM), styrene-butadiene rubber (SBR), acrylonitrile-butadiene rubber (NBR), polyimide (PI), carboxymethyl cellulose (CMD), fluororubber, and the like.

The mixture electrode layer 102 may contain, for example, Ketjen black, acetylene black, carbon black, graphite, a carbon nanotube, a carbon fiber, graphene, amorphous carbon, conductive polymer polyaniline, polypyrrole, polythiophene, polyacetylene, polyacene, or the like as an auxiliary conductive agent.

A secondary battery according to the present embodiment is composed of the negative electrode for a secondary battery 100 in which the above-described mixture electrode layer 102 is used, a positive electrode for a secondary battery that is produced using a well-known method, and an electrolytic solution which is loaded between both electrodes. In the electrolytic solution, fluoroethylene carbonate (FEC) that makes the active material particles 106 in the negative electrode for a secondary battery 100 poorly elastic may be contained. Here, FEC is an expensive material and generates an unnecessary gas, and the amount of FEC in the electrolytic solution is thus preferably suppressed to be 15 wt % or less.

As described below as an example, the negative electrode active material for a secondary battery of the present embodiment contains the second carbon nanotube as the binder and is thereby capable of realizing the active material particles being poorly elastic even when the amount of FEC is suppressed to be 0.1 wt % or less.

### (Manufacturing Method of Negative Electrode Active Material for Secondary Battery)

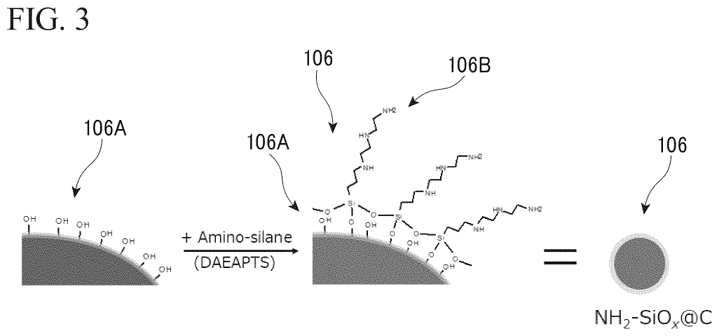

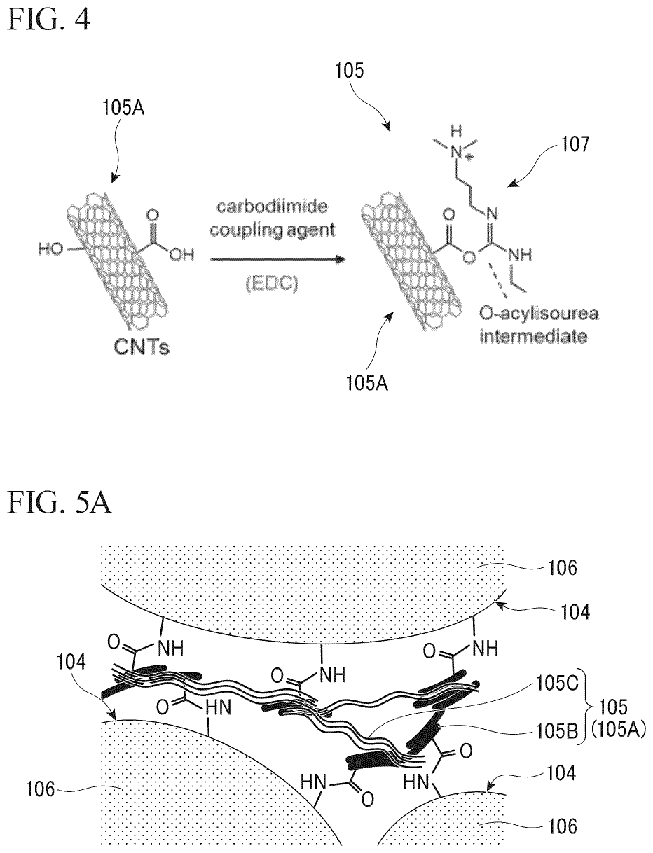

The negative electrode active material for a secondary battery according to the present embodiment can be obtained by producing the active material particles 106 and the binder 105 individually and mixing them together. The active material particle 106 is composed of the silicon composite 103 and the self-assembled monolayer 104 that coats the surface of the silicon composite. The binder 105 is a binder obtained by bonding an EDC (1-ethyl-3-(3-dimethylaminopropyl) carbodiimide hydrochloride) molecule 107 to the long carbon material (carbon nanotube) 105A. A procedure for producing the active material particle 106 and the binder 105 will be each described using FIG. 3 or 4.

FIG. 3 is a view for schematically describing a production step of the active material particle 106. The active material particle 106 can be synthesized by, for example, a dry process. The synthesis of the active material particle 106 by the dry process can be carried out by the following procedure.

First, a powder of carbon-coated silicon monoxide (SiOₓ@C: Osaka Titanium technologies Co., Ltd. or the like) weighed as much as an amount suitable for the use, for example, approximately 2 to 10 g, and spread in a Petri dish is irradiated with ultraviolet rays using ultraviolet irradiation means such as a table top optical surface treatment device (LP16-110, Sen Lights Co., Ltd.). As the powder of the carbon-coated silicon monoxide, a powder having an average particle diameter of 0.1 to 10 μm, approximately 1 to 10 μm in the case of a mass-produced product, is preferably used. The irradiation time with ultraviolet rays is preferably set to 3 to 10 minutes, for example, approximately 5 minutes. The powder of the carbon-coated silicon monoxide may contain Li.

This treatment forms hydroxyl groups (—OH) on the carbon coating and on the surface of the silicon oxide to be exposed and produces a precursor 106A of the active material particle in the Petri dish.

Next, N-[3-(trimethoxysilyl) propyl]diethylenetriamine (DAEAPTS: C₁₀H₂₇N₃O₃Si, Sigma-Aldrich) represented by the following formula (1) is accommodated in a screw tube. The amount accommodated is preferably 25 to 100 μL, for example, approximately 50 μL.

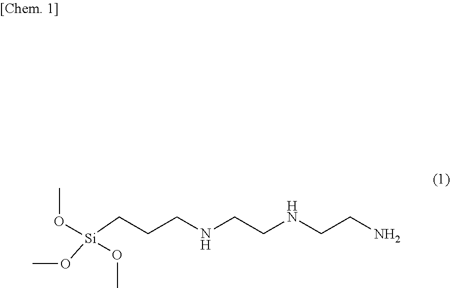 [SMILES: CO[Si](CCCNCCNCCN)(OC)OC]

Next, the above-described Petri dish and screw tube are installed in a SUS airtight container and held at a predetermined temperature for a predetermined time using a constant temperature bath (DRA430DA, ADVANTEC). The holding temperature is preferably set to 80° C. to 150° C., for example, approximately 120° C. The holding time is preferably set to 10 to 20 hours, for example, approximately 15 hours.

This treatment generates the precursor 106A having hydroxyl groups formed on the surface of the active material and produces the active material particle 106 further having amino groups (—NH₂) 106B formed on the hydroxyl groups on the surface of the active material through silicon in the Petri dish.

FIG. 4 is a view for schematically describing a production step of the binder 105. First, a mixed liquid of water and the long carbon material (carbon nanotube) 105A is produced in a predetermined container, and a carboxyl group (—COOH) is formed on the surface of the long carbon material 105A in the mixed liquid.

Subsequently, a solution of the EDC molecule 107 is added to the same container, and the carbon nanotube 105A and the EDC molecule 107 are bonded together through the carboxyl group in the mixed liquid, thereby producing the binder 105 composed of an active ester compound.

Next, the produced active material particles 106 and binder 105 are mixed together in a predetermined container. This makes the amino group in the active material particle 106 and the EDC molecule in the binder 105 amide-bonded to each other as shown in FIG. 2 and makes it possible to produce the mixture electrode layer 102 in the mixed liquid. In the produced mixture electrode layer 102, a plurality of granular silicon composites 103 containing nano-silicon has been laminated (deposited) on the one surface 101a of the current collector in a state of being non-covalently bonded to the carbon nanotubes 105A through the self-assembled monolayer 104 that coats the surface due to tension in association with an electrostatic interaction. In the case of using a powder of carbon-coated silicon monoxide containing lithium in a step 1, this lithium is contained in the silicon composites 103 in a Li₄SiO state.

### (Manufacturing Method for Negative Electrode for Secondary Battery)

The mixed liquid of the mixture electrode layer 102 obtained by the above-described procedure is added dropwise onto a current collector, pressed using a pressing member and then dried in a vacuum, thereby removing an unnecessary liquid in the mixed liquid. Therefore, the negative electrode for a secondary battery 100 as shown in FIG. 1 is obtained.

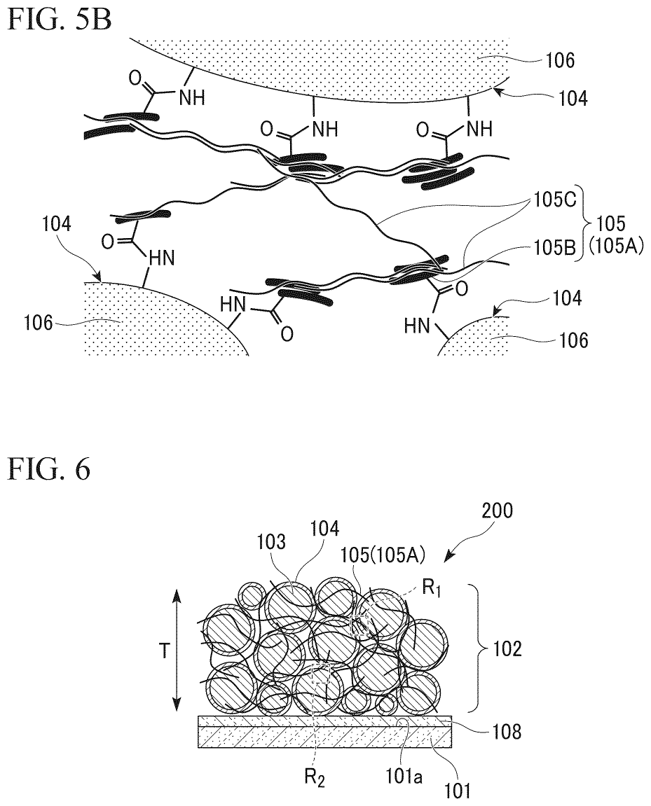

FIG. 5A and FIG. 5B are each an image diagram of first carbon nanotubes 105B or second carbon nanotubes 105C during the expansion or shrinkage of the active material particles 106.

The plurality of first carbon nanotubes 105B is each covalently bonded to the amino group on the surface of the active material particle 106. Furthermore, the second carbon nanotubes 105C are bonded to the individual first carbon nanotubes 105B at a plurality of places while bundling the plurality of first carbon nanotubes 105B. These bonds are weak and thus reassembled depending on an external force that is exerted on the first carbon nanotubes 105B, which consequently makes the bonding places slide.

When the active material particles 106 have expanded, the plurality of first carbon nanotubes 105B comes close to each other as shown in FIG. 5A. Accordingly, the bonding places between the plurality of first carbon nanotubes 105B and the second carbon nanotubes 105C slide to come close to each other.

When the active material particles 106 have shrunk, the plurality of first carbon nanotubes 105B gets away from each other as shown in FIG. 5B. Accordingly, the bonding places between the plurality of first carbon nanotubes 105B and the second carbon nanotubes 105C slide to get away from each other.

The bonding places slide as described above, whereby a load that is applied to the bonding places when the active material particles 106 expand or shrink can be relieved, and it is thus possible to avoid a problem of the conduction between the active material particles 106 being hindered due to the breakage of the bonds. Since the second carbon nanotubes 105C have excellent stretchability, even when an external force exceeding the sliding limit of the bonding place is exerted, the second carbon nanotubes 105C stretch and contract to relieve this external force, and it is possible to assist the bonds to be maintained.

As described above, the negative electrode active material for a secondary battery of the present embodiment contains the long and thin second carbon nanotubes having a length of 2 μm or more as a poorly elastic binder that binds the active material particles 106 together. The second carbon nanotubes have a high cohesive force and are distributed in a state of intertwining the first carbon nanotubes and closely adhering to the surfaces of the active material particles 106. Therefore, the second carbon nanotubes are capable of deforming along with a volume change of the active material particles 106 and of intertwining and strongly bonding the active material particles 106 together. Therefore, it is possible to avoid a problem of the binder being peeled off due to a volume change of the active material particles during charging and discharging and the consequent decrease in the conductivity. Furthermore, these second carbon nanotubes have a high electron conductivity and function as robust conduction paths that continuously follow the volume change, and it is thus possible to realize charging and discharging in a state where the resistance in the negative electrode has been decreased and to maintain the capacity in a high state.

In the case of using a silicon oxide active material, in the process of a reaction during charging, some of lithium forms a compound with silicon oxide and is consumed, and a part of the amount of electricity charged is thus lost. However, in a case where lithium has been contained in the silicon compound body in advance, this lithium compensates for the consumed lithium, a decrease in the total amount of lithium that contributes to electrical conduction can be suppressed, and it is possible to maintain the amount of electricity to be discharged.

In the case of not containing an insulating binder such as PVDF or SBR, the mixture electrode layer 102 having the above-described configuration contains a conductive material containing two carbon nanotubes having different lengths in an extremely high fraction, and the electrical resistance thus becomes low. In addition, since the weight ratio of the active material particles 106 in the mixture electrode layer 102 is high, a lithium-ion secondary battery having a high capacity per weight, that is, a lithium-ion secondary battery having a high energy density can be obtained by including this mixture electrode layer 102. Furthermore, the adhesion of the mixture electrode layer 102 to the current collector 101 is high, and a lithium-ion secondary battery capable of withstanding even a large current, that is, a lithium-ion secondary battery having a high output density can be thus obtained by including this mixture electrode layer 102.

In the conductive binder 105, the first carbon nanotubes 105B mainly couple the adjacent active material particles 106 to each other. This forms electron conduction paths between the adjacent active material particles 106 and forms a network structure that is reticular three-dimensionally on the current collector 101. Due to the action of such first carbon nanotubes 105B, the active material particles 106 are held on the current collector 101 without dropping from the mixture electrode layer 102.

One of the causes for deterioration in the long-term use of a lithium-ion secondary battery is the physical separation of the active material particles 106 from the conduction paths in an electrode. Particularly, the peeling of the mixture electrode layer 102 from the current collector 101 is critical since a large amount of the active material particles 106 are separated from the conduction paths. Therefore, it is normal to contain a binder that couples the active material particles 106 in the mixture electrode layer 102.

Incidentally, in the present invention, the first carbon nanotubes 105B play a role of forming the above-described reticular network structure, whereby the desorption of the active material particles 106 from the conduction paths in the electrode can be suppressed, and it is thus possible to develop high adhesion between the active material particles 106 or sufficient adhesion of the active material particles 106 to the current collector 101 without containing a binder in the mixture electrode layer 102.

In the conductive binder 105, the second carbon nanotubes 105C couple not only the adjacent active material particles 106 but also other active material particles 106 that are positioned around the above-described active material particles, and a continuous electron conduction path having a low resistance is thus formed between a large number of the active material particles 106 compared with that in a case where the carbon nanotubes that are contained in the conductive binder 105 are only the first carbon nanotubes 105B. Due to the action of such second carbon nanotubes 105C, the electrical conductivity significantly improves.

As described above, the first carbon nanotubes 105B play a role of forming the above-described reticular network structure, whereby the active material particles 106 are mechanically connected with each other, and it is possible to develop sufficient adhesion of the active material particles 106 to the current collector 101. In addition, the second carbon nanotubes 105C play a role of forming a continuous electron conduction path having a low resistance, whereby, compared with a case where the carbon nanotubes are only composed of the first carbon nanotubes 105B, the active material particles 106 are electrically connected with each other, and the electrical conductivity in the mixture electrode layer 102 remarkably improves. Furthermore, the first carbon nanotubes 105B are made to play a role of coupling the active material particles 106 together, whereby there is no need to contain a binder in the mixture electrode layer 102, and it is thus possible to contain the active material particles 106 in the mixture electrode layer 102 in an extremely high fraction.

In addition, highly crystalline carbon materials are described as a collection of graphene sheets composed of carbon alone. However, the end or defective part of this graphene sheet is normally terminated with hydrogen, but is highly active and is likely to be substituted with a functional group depending on the ambient environment. For example, in the case of carrying out a dispersion treatment in water on a carbon nanotube in which the graphene sheet is tubularly formed, when the carbon nanotube is cut, the end is modified with a hydroxyl group derived from water due to the activity of the cut surface. Therefore, there are a large number of active surfaces that are generated in water as in a carbon nanotube in which there is a constriction, a hydrophilic group is likely to be attached.

As described above, a hydrophilic group on a fibrous carbon nanotube forms a hydrogen bond with a hydrophilic group on another carbon nanotube or a hydrophilic group on the surface of the current collector 101, whereby a network in which a plurality of the carbon nanotubes is fixed to the current collector 101 is configured, and the active material particles 106 can be held without being dropped from the mixture electrode layer 102.

### Second Embodiment

FIG. 6 is a cross-sectional view schematically showing the configuration of a part of a negative electrode for a secondary battery 200 including a negative electrode active material for a secondary battery according to a second embodiment of the present invention. The negative electrode for a secondary battery 200 further includes a carbon film 108 between the one surface 101a of the current collector and the mixture electrode layer 102. The thickness of the carbon film 108 is preferably 0.5 μm or more and 2 μm or less. The other configurations are the same as those of the negative electrode for a secondary battery 100 of the first embodiment and exhibit the same effect as that of at least the negative electrode for a secondary battery 100. In addition, places corresponding to the negative electrode for a secondary battery 100 will be indicated by the same reference signals.

In the negative electrode for a secondary battery 200 of the present embodiment, since the carbon film 108 is provided between the mixture electrode layer 102 and the current collector 101, the long carbon material 105A (particularly, the second carbon nanotubes) in the mixture electrode layer 102 strongly bonds to the current collector 101 through the carbon film 108. Therefore, it is possible to suppress the mixture electrode layer 102 being peeled off from the current collector 101 in association with a volume change during charging and discharging.

### EXAMPLES

Hereinafter, the effect of the present invention will be further clarified with examples. The present invention is not limited to the following examples and can be appropriately modified and carried out within the scope of the gist of the present invention.

### Example 1

A secondary battery according to the above-described embodiment was manufactured by the following procedure (steps 1 to 6).

### [Step 1]

First, a carbon-coated silicon monoxide powder (SiOₓ@C: Osaka Titanium technologies Co., Ltd. or the like) weighed as much as approximately 5 g and spread in a Petri dish was irradiated with ultraviolet rays using a tabletop optical surface treatment device (LP16-110, Sen Lights Co., Ltd.). As the carbon-coated silicon monoxide powder, a powder having an average particle diameter of 5 μm was used. The irradiation time with ultraviolet rays was set to 5 minutes.

Next, 50 μL of N-[3-(trimethoxysilyl) propyl]diethylenetriamine (DAEAPTS: C₁₀H₂₇N₃O₃Si, Sigma-Aldrich) was accommodated in a screw tube.

Next, the above-described Petri dish and screw tube were installed in a SUS airtight container and held at 120° C. for 15 hours using a constant temperature bath (DRA430DA, ADVANTEC), thereby producing active material particles in the Petri dish.

### [Step 2]

In addition, carbon nanotubes were mixed with water (H₂O) accommodated in another container at room temperature such that the content thereof reached 2 wt %, and a mixed liquid containing a binder having a carboxyl group (—COOH) formed on a surface was produced. As the carbon nanotubes, carbon nanotubes including first carbon nanotubes and second carbon nanotubes in a weight ratio of 9:1 were used.

As the first carbon nanotubes, approximately 10 to 15 layers of multi-walled carbon nanotubes (MWCNT) having lengths of approximately 200 to 700 nm and diameters of approximately 20 to 30 nm were used. As the second carbon nanotubes, single-walled carbon nanotubes (SWCNT) having lengths of approximately 5 to 10 μm and diameters of approximately 2 to 3 nm were used.

### [Step 3]

Next, the active material particles produced in the step 1 and the mixed liquid produced in the step 2 were mixed together at room temperature to produce a mixed liquid of the active material particles, the binder, and water. The weight ratio of the active material particles and the binder in the mixed liquid was adjusted to be 98:2.

### [Step 4]

Next, the mixed liquid produced in the step 3 was added dropwise onto a current collector composed of copper (copper foil), and blade coating was carried out using a pressing member.

### [Step 5]

Subsequently, the water that was contained in the coated mixed liquid was dried in a vacuum at 80° C. and removed, thereby obtaining a negative electrode for a secondary battery having a negative electrode active material for a secondary battery formed on the current collector.

### [Step 6]

A secondary battery (coin cell) composed of the obtained negative electrode for a secondary battery, a counter electrode containing metallic Li, and an electrolytic solution (LiPF₆) that was loaded between both electrodes was manufactured. Here, FEC (fluoroethylene carbonate) was not contained as an additive of the electrolytic solution.

### Example 2

A secondary battery was manufactured in the same manner as in Example 1 except that, in the step 4, the current collector onto which the mixed liquid had been added dropwise was replaced by a current collector having a carbon film (thickness: 1 μm) formed on a surface of the copper foil.

### Example 3

A secondary battery was manufactured in the same manner as in Example 2 except that the mixed liquid produced in the step 3 was prepared such that the weight fractions of the active material particles and the binder in the mixed liquid reached 97:3.

### Example 4

A secondary battery was manufactured in the same manner as in Example 2 except that the mixed liquid produced in the step 3 was prepared such that the weight fractions of the active material particles and the binder in the mixed liquid reached 95:5.

### Example 5

A secondary battery was manufactured in the same manner as in Example 2 except that the mixed liquid produced in the step 3 was prepared such that the weight fractions of the active material particles and the binder in the mixed liquid reached 90:10.

### Example 6

A secondary battery was manufactured in the same manner as in Example 2 except that, in the step 6, 5 wt % of FEC was contained as an additive of the electrolytic solution.

### Example 7

A secondary battery was manufactured in the same manner as in Example 4 except that, in the step 6, 5 wt % of FEC was contained as an additive of the electrolytic solution.

### Example 8

A secondary battery was manufactured in the same manner as in Example 5 except that, in the step 6, 5 wt % of FEC was contained as an additive of the electrolytic solution.

### Example 9

A secondary battery was manufactured in the same manner as in Example 1 except that, in the step 1, a powder of carbon-coated silicon monoxide containing Li was used.

### Comparative Example 1

As the carbon nanotubes that were mixed with water in the step 2, only the first carbon nanotubes (MWCNT) were used, and the second carbon nanotubes (SWCNT) were not used. In addition, the mixed liquid that was produced in the step 3 was prepared such that the weight fractions of the active material particles and MWCNT in the mixed liquid reached 90:10. A secondary battery was manufactured in the same manner as in Example 1 regarding the other procedure.

### Comparative Example 2

As the carbon nanotubes that were mixed with water in the step 2, the first carbon nanotubes (MWCNT), styrene-butadiene rubber (SBR), and carboxylmethyl cellulose (CMC) were used, and the second carbon nanotubes (SWCNT) were not used. In addition, the mixed liquid that was produced in the step 3 was prepared such that the weight fractions of the active material particles, MWCNT, SBR, and CMC in the mixed liquid reached 90:4:3:3. A secondary battery was manufactured in the same manner as in Example 1 regarding the other procedure.

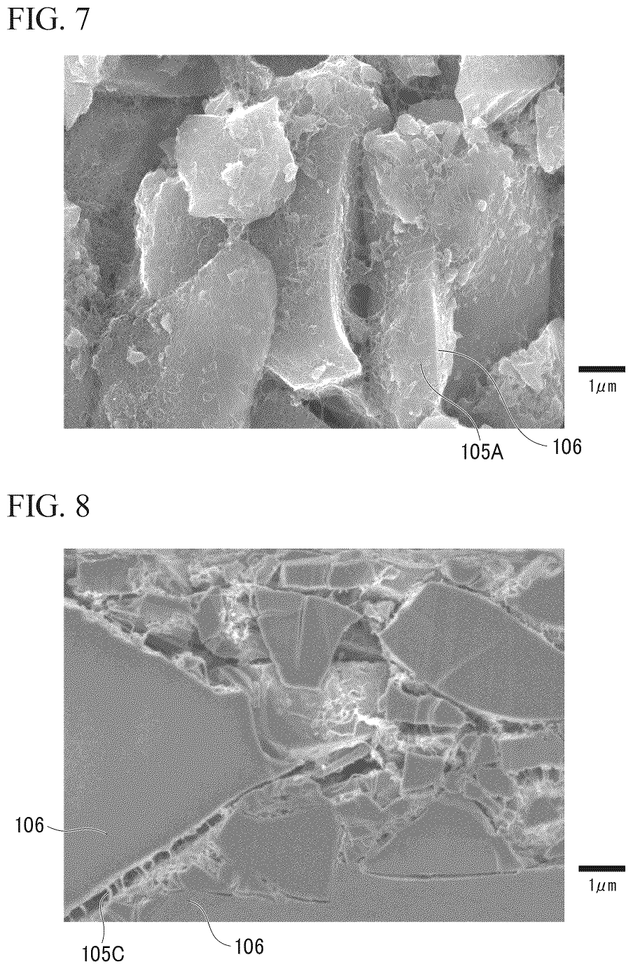

FIGS. 7 and 8 are each a SEM image of the surface or cross section of the negative electrode active material for a secondary battery obtained in Example 1. From FIG. 7, it is found that the long carbon material 105A containing the plurality of first carbon nanotubes and second carbon nanotubes is distributed on the surfaces of the active material particles 106 in a state of being intricately intertwined with each other. From FIG. 8, it is found that the plurality of second carbon nanotubes 105C cohere together and the active material particles 106 adjacent to each other have been coupled together.

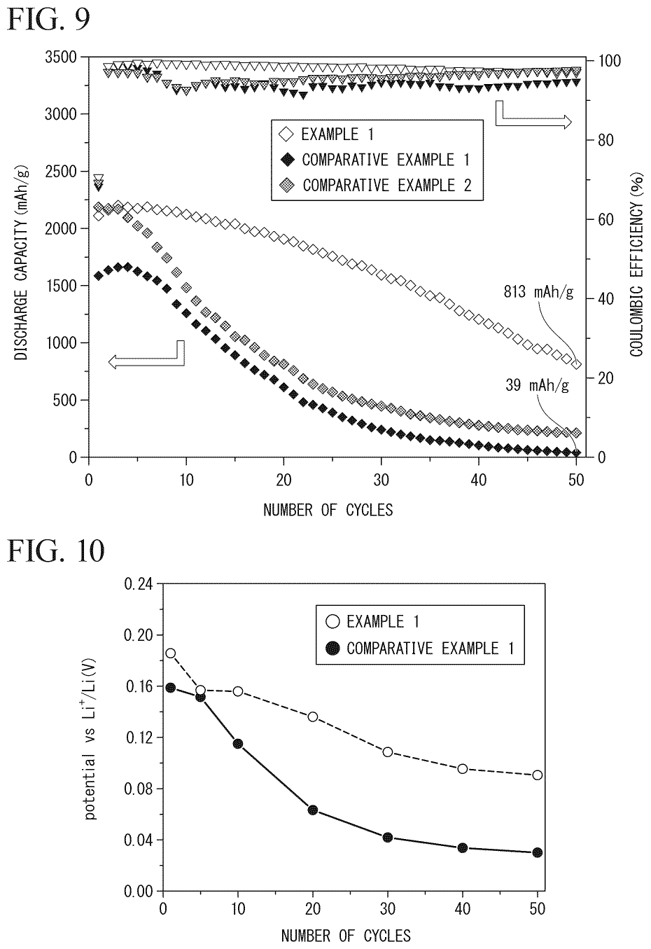

The cycle tests of the discharge capacity were carried out on the secondary batteries (coin cells) obtained in Example 1 and Comparative Examples 1 and 2. The discharge time was set to five hours (0.2 C). FIG. 9 is graphs showing the test results. The horizontal axis of the graphs indicates the number of cycles (the number of repetitions of charging and discharging). The vertical axes (on the right side and on the left side) of the graphs indicate the columbic efficiency (%) and the discharge capacity (mAh/g).

The discharge capacities of Comparative Examples 1 and 2 rapidly deteriorated as charging and discharging was repeated and reached approximately 30% of the initial values after 20 cycles. In contrast, the discharge capacity of Example 1 rarely deteriorated after 20 cycles and was maintained at 35% or more of the initial value even after 50 cycles.

Cycle tests at an average working voltage were carried out on the secondary batteries obtained in Example 1 and Comparative Example 1. FIG. 10 is graphs showing the test results. The horizontal axis of the graphs indicates the number of cycles, and the vertical axis of the graphs indicates the average working voltage (V).

The average working voltage of Comparative Example 1 rapidly deteriorated as charging and discharging was repeated and reached approximately 10% of the initial value after 50 cycles. In contrast, the average working voltage of Example 1 gently deteriorated and could be maintained at approximately 50% of the initial value even after 50 cycles.

From the test results of FIGS. 9 and 10, it is found that, in Example 1, long and thin single-walled carbon nanotubes are contained in the binder that covers the active material particles and the peeling of the binder and an auxiliary conductive agent, the crushing of the active material particles or the like in association with the volume expansion of the active material particles is reduced compared with that in Comparative Examples 1 and 2.

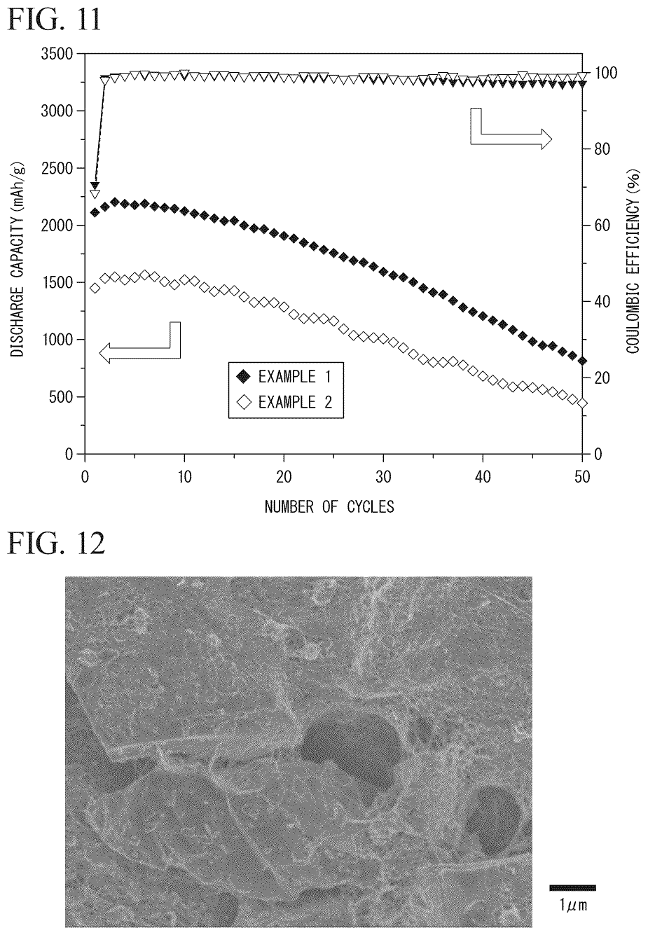

Cycle tests of the discharge capacity and the columbic efficiency were carried out on the secondary batteries obtained in Examples 1 and 2. FIG. 11 is graphs showing the test results in a case where the discharge time is set to five hours (0.2 C). The horizontal axis of the graphs indicates the number of cycles. The vertical axes (on the right side and on the left side) of the graphs indicate the columbic efficiency (%) and the discharge capacity (mAh/g).

From the test results of FIG. 11, it is found that, in both of Examples 1 and 2, the changes in the discharge capacity and the columbic efficiency are small and high capacities can be maintained even when charging and discharge is repeated. From these results, it is found that the peeling of the binder and the auxiliary conductive agent, the crushing of the active material particles, or the like in association with the volume expansion of the active material particles has been suppressed due to the single-walled carbon nanotubes regardless of the configuration of the current collector. It is found that, regarding the discharge capacities of Examples 1 and 2, the initial magnitudes are different from each other but the degrees of deterioration are approximately the same as each other.

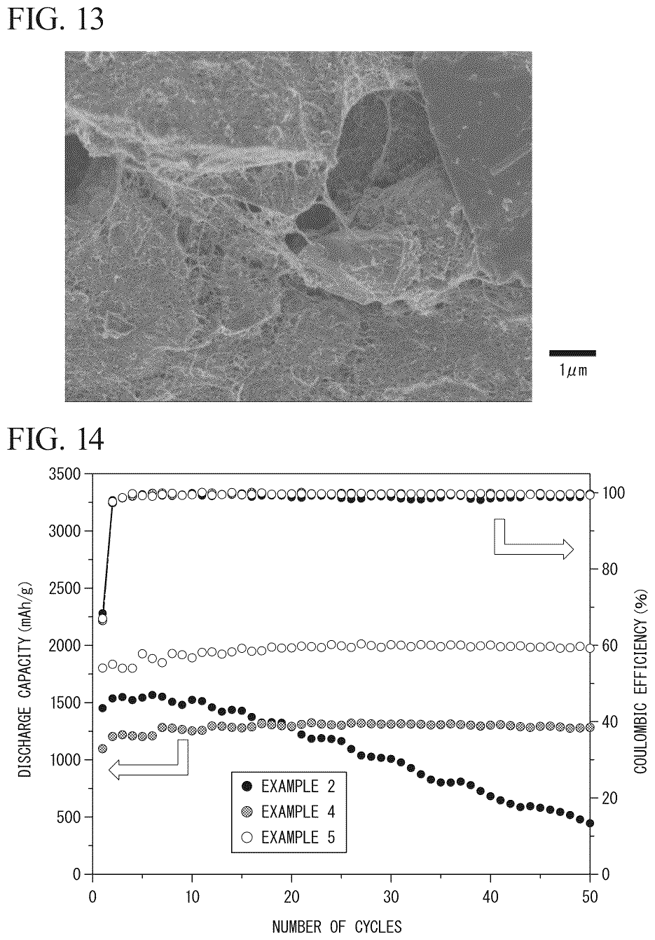

FIGS. 12 and 13 are each a SEM image of the cross section of the negative electrode active material for a secondary battery obtained in Example 4 or 5. It is found that, compared with the space between the active material particles 106 of Example 1 in FIG. 8, a larger number of the second carbon nanotubes 105C cohere together in the space between the active material particles 106 of Example 4 and a far larger number of the second carbon nanotubes 105C cohere together in the space between the active material particles 106 of Example 5. From this fact, it is conceivable that, as the amount of the binder 105 becomes higher, and furthermore, as the amount of the second carbon nanotubes 105C becomes higher, the coupling between the active material particles 106 adjacent to each other becomes stronger.

The cycle tests of the discharge capacity and the columbic efficiency were carried out on the secondary batteries obtained in Examples 2, 4, and 5. The discharge time was set to five hours (0.2 C). FIG. 14 is graphs showing the test results. The horizontal axis of the graphs indicates the number of cycles. The vertical axes (on the right side and on the left side) of the graphs indicate the columbic efficiency (%) and the discharge capacity (mAh/g).

In all of Examples 2, 4, and 5, capacity deterioration in association with the repetition of charging and discharging has been suppressed. It is found that, compared with the capacity value of Example 2, the capacity value of Example 4 is maintained at a higher value and the capacity value of Example 5 is maintained at a far higher value. From this fact, it is conceivable that, as the amount of the binder 105 becomes higher, and furthermore, as the amount of the second carbon nanotubes 105C becomes higher, the coupling between the active material particles 106 adjacent to each other becomes stronger.

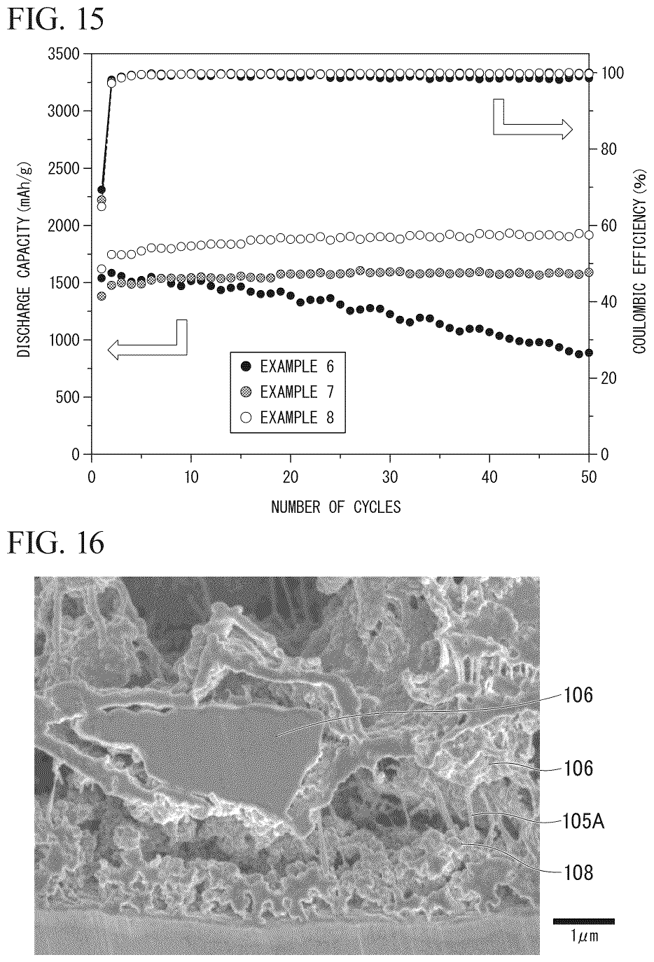

The cycle tests of the discharge capacity and the columbic efficiency were carried out on the secondary batteries obtained in Examples 6 to 8. The discharge time was set to five hours (0.2 C). FIG. 15 is graphs showing the test results. The horizontal axis of the graphs indicates the number of cycles. The vertical axes (on the right side and on the left side) of the graphs indicate the columbic efficiency (%) and the discharge capacity (mAh/g).

In all of Examples 6 to 8 as well, capacity deterioration in association with the repetition of charging and discharging has been suppressed. It is found that, compared with the capacity value of Example 6, the capacity value of Example 7 is maintained at a higher value and the capacity value of Example 8 is maintained at a far higher value. From this fact, it is conceivable that, as the amount of the binder 105 becomes higher, and furthermore, as the amount of the second carbon nanotubes 105C becomes higher, the coupling between the active material particles 106 adjacent to each other becomes stronger.

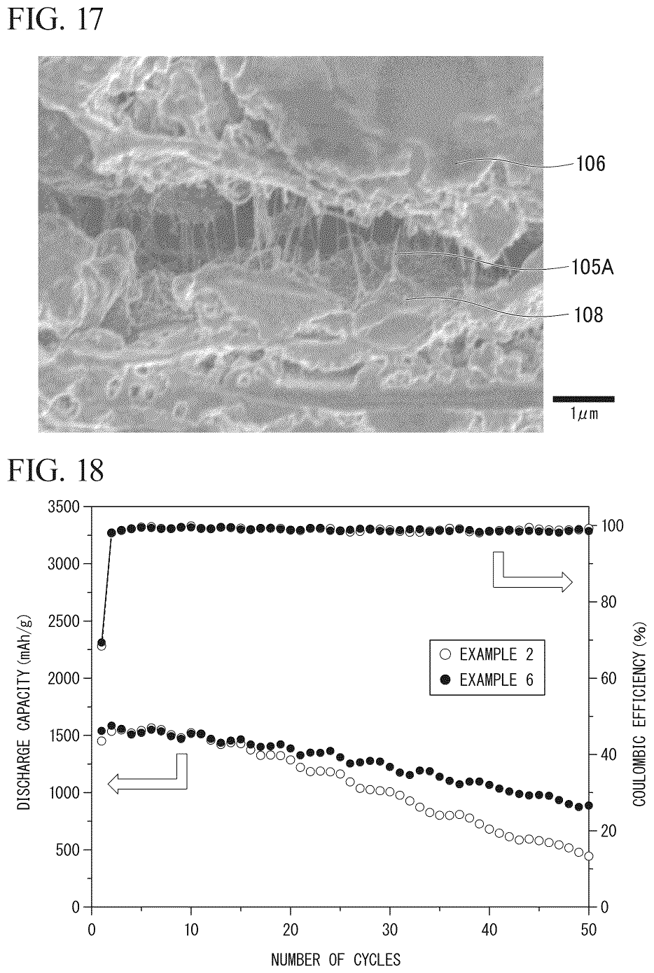

FIGS. 16 and 17 are SEM images of the cross sections of the negative electrodes for a secondary battery of Examples 7 and 8 after the cycle tests. It is found that, even after the cycle tests, a large number of the second carbon nanotubes 105C cohere together in the space between the carbon film 108 and the active material particle 106 and the carbon film 108 and the active material particle 106 are strongly bonded to each other. In the second carbon nanotube 105C that contributes to this bonding, one end bonds to the amino group in the active material particle 106 by a condensation reaction with EDC. On the other hand, the other end gets into the carbon film 108 and is strongly bonded thereto by an intermolecular force. Since the mixture electrode layer 102 is strongly bonded to the current collector 101 through the carbon film 108, it is possible to avoid a problem of the mixture electrode layer being peeled off from the current collector 101 in association with the volume expansion of the active material particles during charging and discharging or the like.

The cycle test of the discharge capacity and the columbic efficiency was carried out on each of the secondary batteries of Examples 2 and 6. The discharge time was set to five hours (0.2 C). FIG. 18 is graphs showing the test results. The horizontal axis of the graphs indicates the number of cycles. The vertical axes (on the right side and on the left side) of the graphs indicate the columbic efficiency (%) and the discharge capacity (mAh/g).

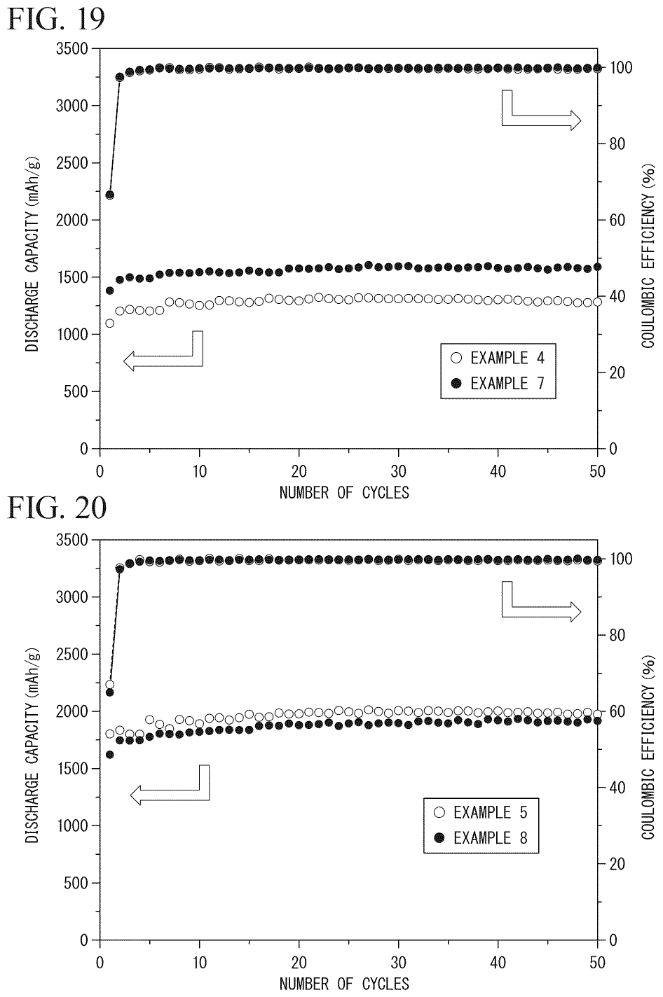

The cycle test of the discharge capacity and the columbic efficiency was carried out on each of the secondary batteries of Examples 4 and 7. The discharge time was set to five hours (0.2 C). FIG. 19 is graphs showing the test results. The horizontal axis of the graphs indicates the number of cycles. The vertical axes (on the right side and on the left side) of the graphs indicate the columbic efficiency (%) and the discharge capacity (mAh/g).

The cycle test of the discharge capacity and the columbic efficiency was carried out on each of the secondary batteries of Examples 5 and 8. The discharge time was set to five hours (0.2 C). FIG. 20 is graphs showing the test results. The horizontal axis of the graphs indicates the number of cycles. The vertical axes (on the right side and on the left side) of the graphs indicate the columbic efficiency (%) and the discharge capacity (mAh/g).

The capacity characteristics of the secondary battery of Example 2 become low compared with the capacity characteristics of the secondary battery of Example 6. In contrast, the secondary batteries of Example 4 and Example 7 show the same capacity characteristics, and the secondary batteries of Example 5 and Example 8 show the same capacity characteristics. From these results, it is found that, in secondary batteries containing a large amount of a binder (carbon nanotubes), even when FEC is not contained in an electrolytic solution, an effect of making active material particles poorly elastic can be obtained and the peeling of the binder and the like, the crushing of the active material particles or the like in association with the volume expansion of the active material particles can be sufficiently suppressed.

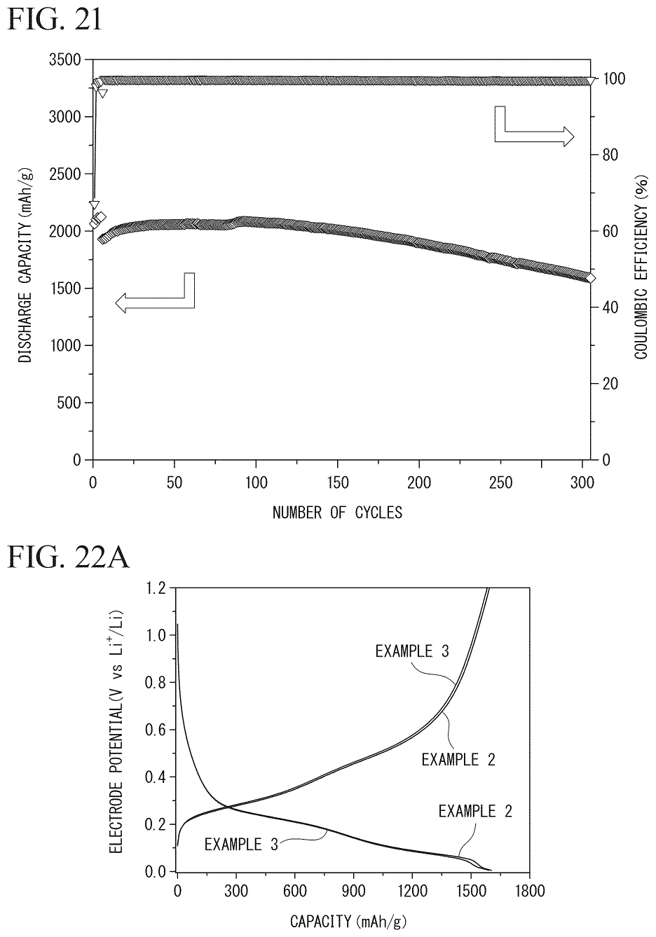

The cycle test of the discharge capacity and the columbic efficiency was carried out on the secondary battery of Example 8 for a discharge time set to five hours (0.2 C). FIG. 21 is graphs showing the test results. The horizontal axis of the graphs indicates the number of cycles. The vertical axes (on the right side and on the left side) of the graphs indicate the columbic efficiency (%) and the discharge capacity (mAh/g).

From the comparison between FIGS. 20 and 21, it is found that changes in the discharge capacity and the columbic efficiency caused by an increase or decrease in the discharge rate are small and high capacities can be maintained even when charging and discharging is repeated at any discharge rate. From this fact, it is conceivable that the peeling of the binder and the like, the crushing of the active material particles or the like in association with the volume expansion of the active material particles can be sufficiently suppressed at any discharge rate.

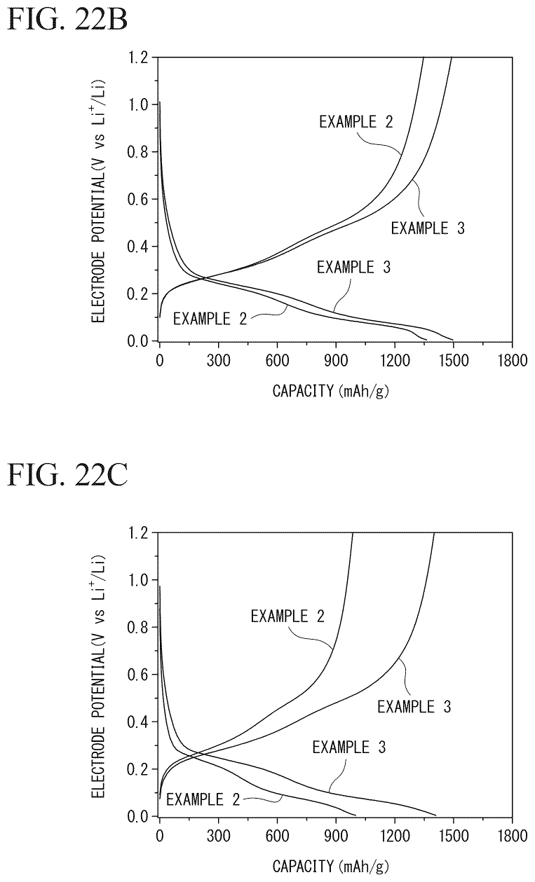

Three samples of each of the secondary batteries of Examples 2 and 3 were prepared, and cycle tests were carried out by repeatedly charging and discharging each of the samples 10 times, 30 times, or 50 times. Each of the samples after the cycle tests was set in a potentiostat/galvanostat, and Li was inserted into and desorbed from the negative electrode in a range of 0 V to 1.2 V. FIGS. 22A, 22B, and 22C are each graphs showing the results of the samples of Example 2 or 3 for which the number of times (the number of cycles) of charging and discharging was set to 10, 30, or 50.

In a case where the number of cycles was 10, the capacities of Examples 2 and 3 are almost the same; however, when the number of cycles increase to 30, the capacity of Example 2 becomes low relative to the capacity of Example 3. When the number of cycles increases to 50, the capacity of Example 2 becomes lower relative to the capacity of Example 3, and the difference therebetween enlarges. From these results, it is found that, as the fraction of the carbon nanotubes that are contained in the mixture electrode layer becomes smaller, the capacity further decreases and, as the number of cycles increases, the width of the decrease becomes larger.

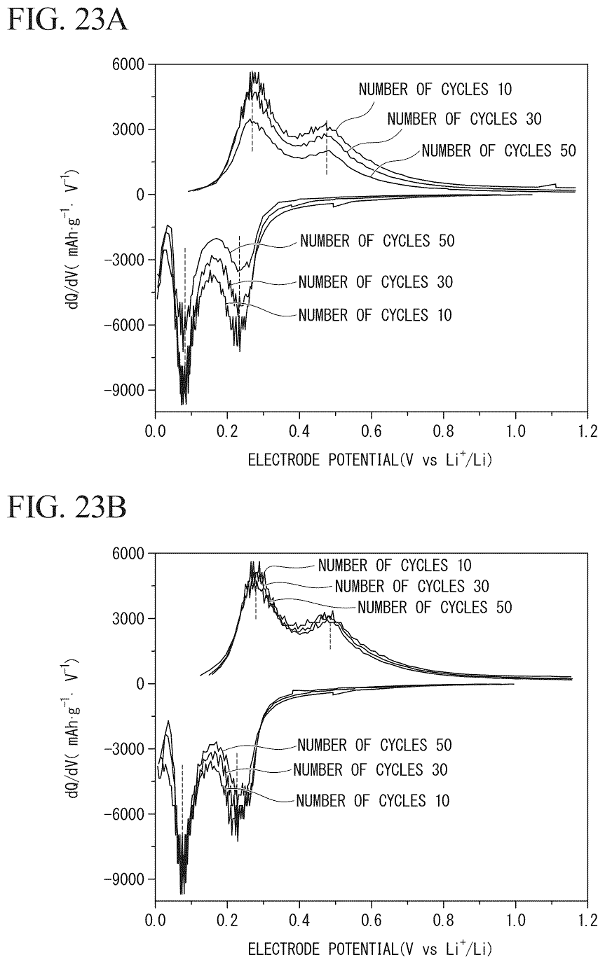

For each of the samples of Example 2 for which the number of cycles was set to 10, 30, or 50 and the samples of Example 3 for which the number of times of charging and discharging was set to 10, 30, or 50, dQ/dV was calculated. FIGS. 23A and 23B are each graphs showing the calculation results.

The heights of the peaks of the dQ/dV curves are related to the connection states of the active material particles with the carbon nanotubes. In the samples of Example 2, since the peak becomes lower as the number of cycles increases, it is conceivable that the number of contact points between the carbon nanotubes and the active material particles decreases with the number of times of charging and discharging and the utilization efficiency of the active material decreases. In contrast, in the samples of Example 3, since a decrease in the peak due to the number of cycles is small, it is conceivable that the utilization efficiency of the active material can be almost maintained even after the cycle test. From these results, it is found that, as the fraction of the carbon nanotubes that are contained in the mixture electrode layer increases, the influence of the cycle test becomes smaller and the utilization efficiency as a negative electrode is more likely to be maintained.

In both of Examples 2 and 3, since the positions of the peaks are well arranged regardless of the number of cycles, it is found that abnormal deterioration such as the decomposition of the electrolytic solution or the cracking of the active material is not caused by the cycle test.

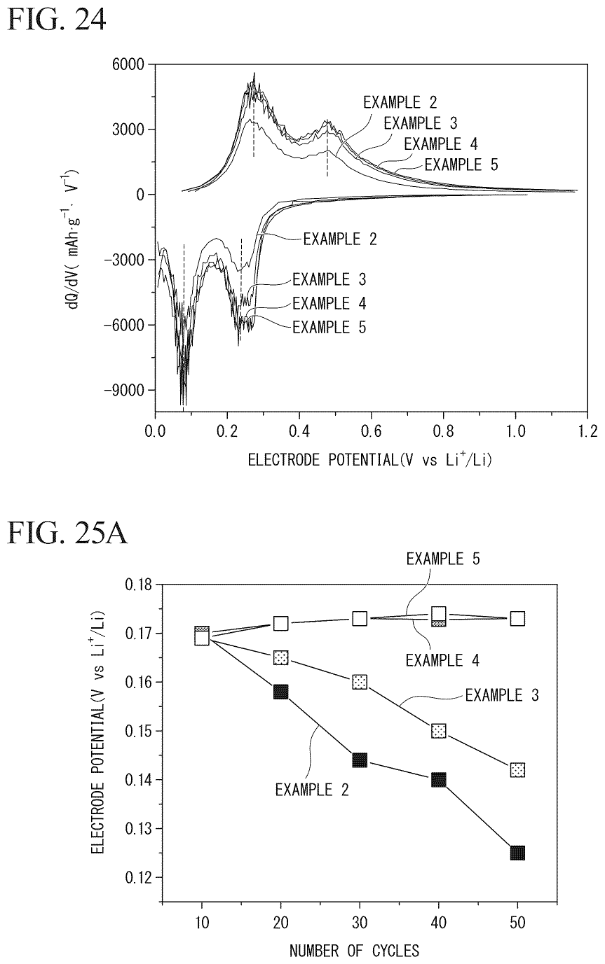

For the samples of Examples 2 to 5 for which the number of times of charging and discharging was set to 50, dQ/dV was calculated. FIG. 24 is graphs showing the calculation results.

The peaks become higher in the order of Examples 2, 3, and 4. On the other hand, the peaks of Examples 4 and 5 have become the same height. From these results, it is found that, when the fraction of the carbon nanotubes that are contained in the mixture electrode layer is within a range of 5% or less, as the fraction becomes higher, the number of contact points between the carbon nanotubes and the active material particles increases. In addition, it is found that, when the fraction of the carbon nanotubes that is contained in the mixture electrode layer is 5%, the number of the contact points between the carbon nanotubes and the active material particles is in the largest state, and this state does not change even when the fraction is made to be larger than 5%.

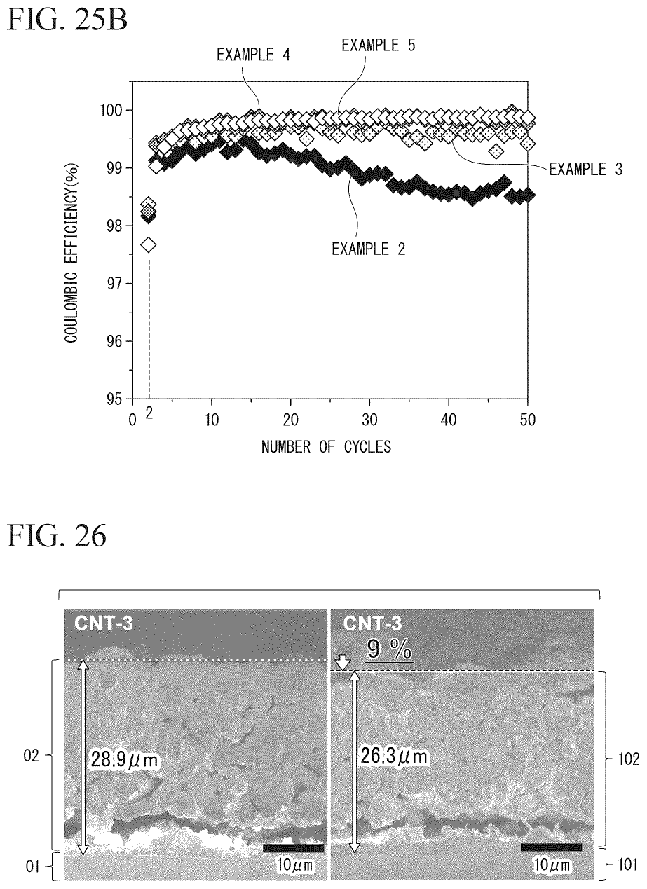

Cycle tests were carried out on the samples of Examples 2, 3, 4, and 5, and changes in the average working voltages during charging as a secondary battery and the columbic efficiencies were measured. FIGS. 25A and 25B are each graphs showing the measurement results of the average working voltages and the columbic efficiencies.

When the fraction of the carbon nanotubes that are contained in the mixture electrode layer is within a range of 5% or less, a tendency of the average working voltage and the columbic efficiency decreasing as the fraction decreases or the number of cycles increases is shown. In addition, when the fraction is within a range of 5% or more, the tendency of the average working voltage and the columbic efficiency decreasing with the number of cycles becomes gentle regardless of the fact that the fractions are the same. From these results, it is found that the carbon nanotubes also have a function of improving the conductivities of secondary batteries and these conductivities can be further improved by increasing the fraction of the carbon nanotubes.

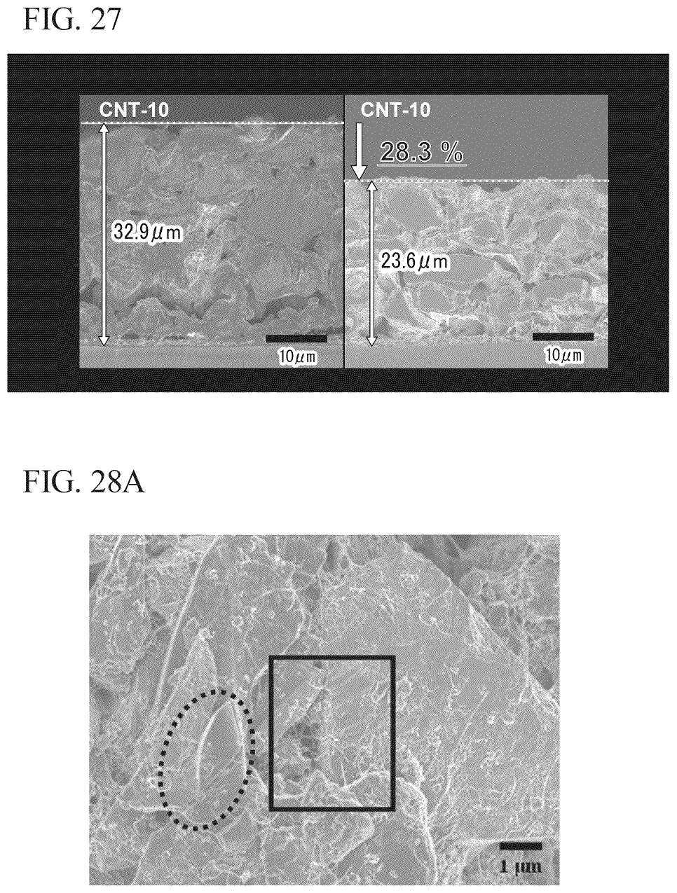

For the samples of Examples 3 and 5, the cross sections of the negative electrodes were observed during charging and during discharging. FIGS. 26 and 27 are each images (FE-SEM images) of the cross sections of the negative electrodes of Examples 3 and 5, the images during charging are on the left side, and the images during discharging are on the right side.

The thickness of the mixture electrode layer of Example 3 has become 28.9 μm during charging and 26.3 μm during discharging, and the decrease rate of the thickness during discharging with respect to the thickness during charging is 9%. The thickness of the mixture electrode layer of Example 5 has become 32.9 μm during charging and 23.6 μm during discharging, and the decrease rate of the thickness during discharging with respect to the thickness during charging is 28.3%. The changes in the thickness are attributed to changes in the volume of the active material particles in the expanded state and in the compressed state.

In both of Examples 3 and 5, the thicknesses during discharging decrease relative to the thicknesses during charging, which makes it possible to confirm the followability of the carbon nanotubes with respect to the volume change of the active material particles.

In addition, the thickness during expansion and the thickness shrinkage rate during shrinkage in Example 5 are both significantly larger than the thickness during expansion and the thickness shrinkage rate during shrinkage in Example 3. From this fact, it is found that the followability of the carbon nanotubes becomes higher as the fraction of the carbon nanotubes that are contained in the mixture electrode layer becomes larger.

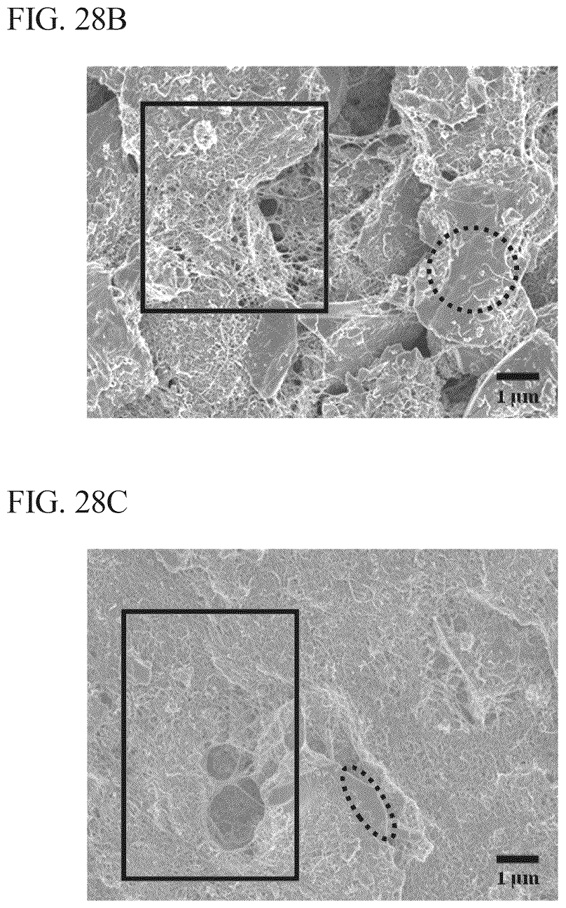

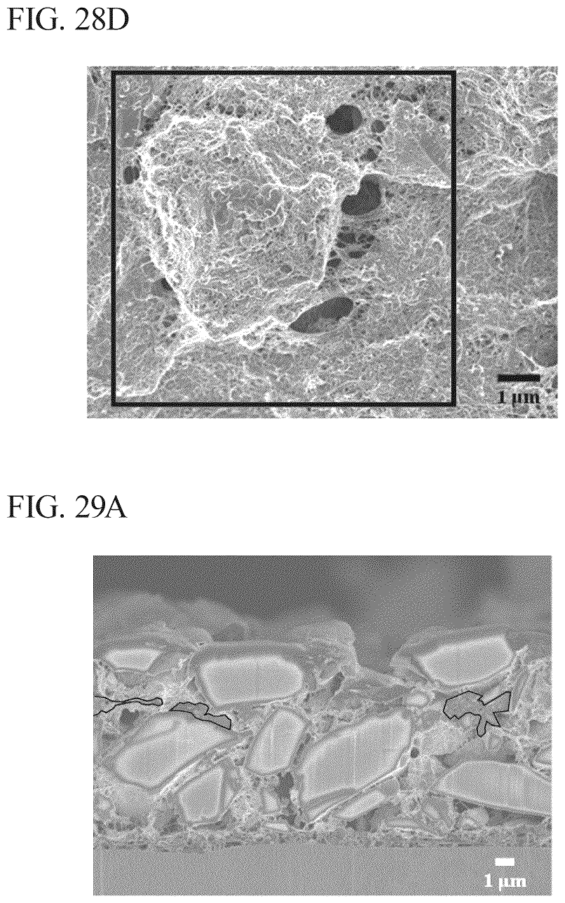

FIGS. 28A, 28B, 28C, and 28D are each an image (FE-SEM image) of the surface of the mixture electrode layer in Example 2, 3, 4, or 5. In the active material particles of Example 2 in which the fraction of the carbon nanotubes is 2%, parts not covered with the carbon nanotubes are shown; however, in the active material particles of Example 5 in which the fraction of the carbon nanotubes is 10%, almost all of the surface is covered with the carbon nanotubes. From the comparison among Examples 2 to 5, it is found that the coating rate of the carbon nanotubes with respect to the active material particles becomes higher as the fraction of the carbon nanotubes that are contained in the mixture electrode layer becomes larger.

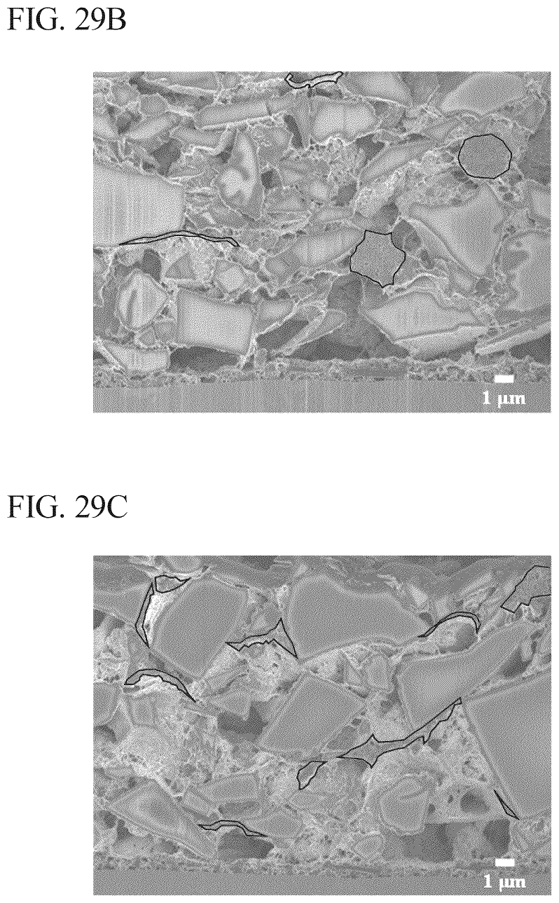

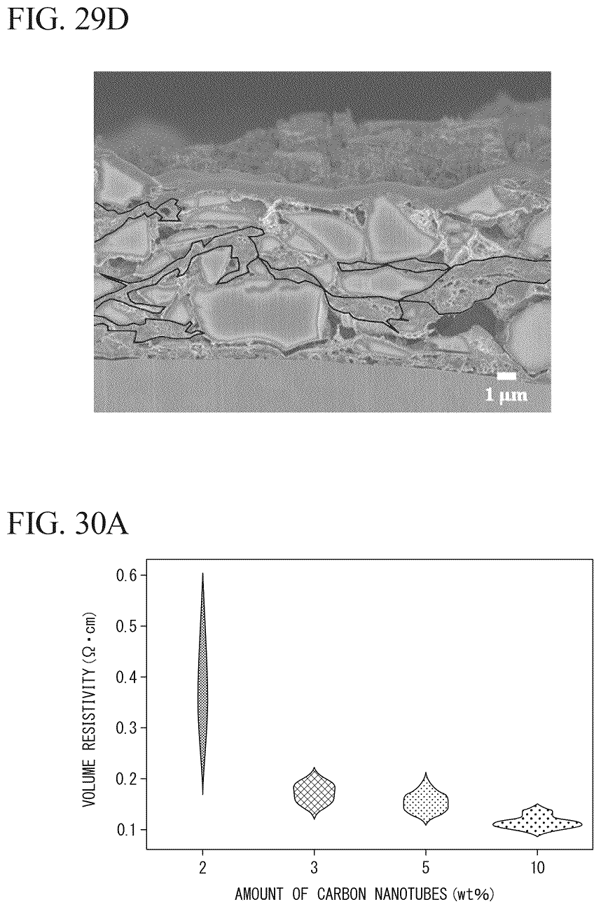

FIGS. 29A, 29B, 29C, and 29D are each an image (FE-SEM image) of the cross section of the mixture electrode layer in Example 2, 3, 4, or 5. Regions surrounded by a thick line indicate regions where the carbon nanotubes are distributed as bundles. Here, the carbon nanotubes are distributed so as to penetrate from front to back. From the comparison among Examples 2 to 5, it is found that the area and number density of the regions where the carbon nanotubes are distributed increase as the fraction of the carbon nanotubes that are contained in the mixture electrode layer becomes larger.

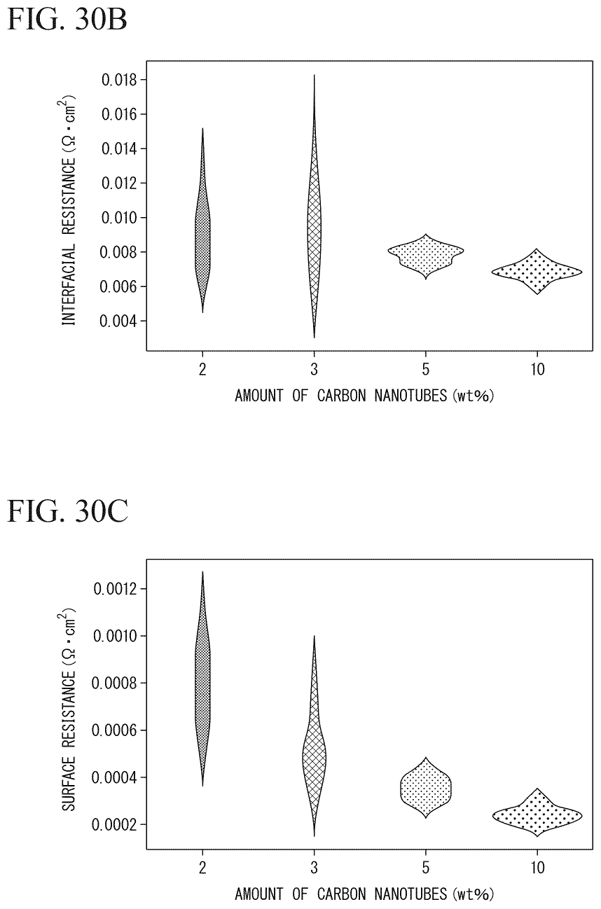

Volume resistivity, interfacial resistance and surface resistance were measured at 16 places on each of the mixture electrode layers of Examples 2 to 5. FIGS. 30A, 30B, and 30C are each graphs showing variations in the measurement results of the volume resistivity, the interfacial resistance, and the surface resistance. The comparison among Examples 2 to 5 in each drawing shows a tendency that the variation in the electrical resistance becomes smaller as the fraction of the carbon nanotubes that are contained in the mixture electrode layer becomes larger. This variation is preferably within 20% from the average value to form a uniform electron conduction network.

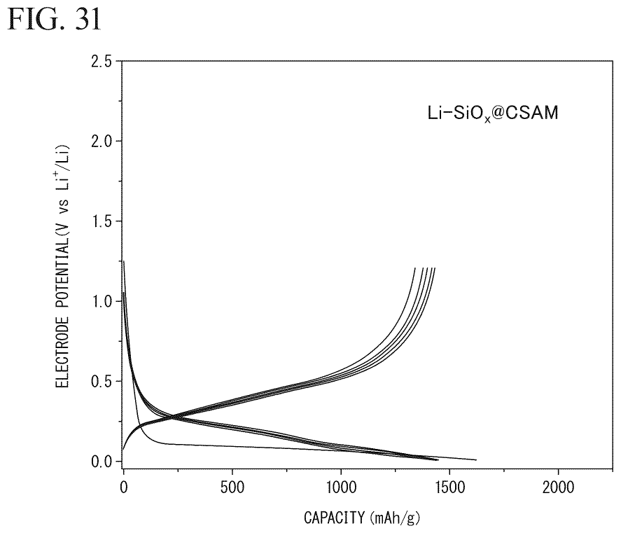

The samples of Example 9 were set in the potentiostat/galvanostat, and Li was inserted into and desorbed from the negative electrode in a range of 0 V to 2.5 V. From FIG. 31, it is found that the charge capacity and the discharge capacity have become almost equal to each other. This is considered to be because lithium has been contained in a silicon compound body in advance, this lithium compensates for a decrease in lithium consumed during charging, a decrease in the total amount of lithium that contributes to electrical conduction can be suppressed, and it is possible to maintain the amount of electricity to be discharged.

### REFERENCE SIGNS LIST

100 Negative electrode for secondary battery
101 Current collector
101a One surface of current collector
102 Mixture electrode layer
103 Silicon composite
104 Self-assembled monolayer
105 Binder
105A Long carbon material
105B First carbon nanotube
105C Second carbon nanotube
106 Active material particle
106A Precursor of active material particle
106B Amino group
107 EDC molecule
108 Carbon film

1. A negative electrode active material for a secondary battery comprising:
an active material particle which contains a silicon composite and a self-assembled monolayer that covers a surface of the silicon composite and has an amino group; and
a binder bonded to the self-assembled monolayer through the amino group,
wherein the binder contains a first carbon nanotube having a length of 1000 nm or less and a second carbon nanotube having a length of 2 m or more.

2. The negative electrode active material for a secondary battery according to claim 1,
wherein the binder is contained in a fraction of 1 wt % or more and 15 wt % or less.

3. The negative electrode active material for a secondary battery according to claim 1,
wherein the second carbon nanotube is contained in the binder in a fraction of 1 wt % or more and 15 wt % or less.

4. The negative electrode active material for a secondary battery according to claim 1,
wherein the first carbon nanotube is a multi-walled carbon nanotube and the second carbon nanotube is a single-walled carbon nanotube.

5. A negative electrode for a secondary battery in which the negative electrode active material for a secondary battery according to claim 1 is used, the negative electrode comprising:
a current collector; and
the negative electrode active material for a secondary battery formed on one surface side of the current collector.

6. The negative electrode for a secondary battery according to claim 5, further comprising:
a carbon film between one surface of the current collector and the negative electrode active material for a secondary battery.

7. A secondary battery comprising:
the negative electrode for a secondary battery according to claim 5;
a positive electrode for a secondary battery; and
an electrolytic solution which is loaded between the negative electrode for a secondary battery and the positive electrode for a secondary battery,
wherein a fraction of fluoroethylene carbonate that is contained in the electrolytic solution is 15 wt % or less.

8. A manufacturing method of the negative electrode active material for a secondary battery according to claim 1, the method comprising:
a step of forming a carbon compound body to which a 1-ethyl-3-(3-dimethylaminopropyl)carbodiimide hydrochloride molecule bonds;
a step of forming a silicon composite to which an amine has bonded; and
a step of mixing and amide-bonding the carbon compound body and the silicon composite in a liquid.
